(19) United States
(12) Patent Application Publication
(10) Pub. No.: US 2004/0250572 A1
(43) Pub. Date: Dec. 16, 2004

(54) Method for producing radiation-resistant quartz glass material, and quartz glass material

(75) Inventors: Ralf Lindner, Oberkochen (DE); Frank Stietz, Lauchheim (DE); Udo Nothelfer, Nersingen (DE); Eric Eva, Aalen (DE)

Correspondence Address: SUGHRUE MION, PLLC, 2100 PENNSYLVANIA AVENUE, N.W., SUITE 800, WASHINGTON, DC, 20037, US

(73) Assignee: Carl Zeiss SMT AG

(21) Appl. No.: 10/782,935

(22) Filed: Feb. 23, 2004

(30) Foreign Application Priority Data
Feb. 21, 2003 (DE) 103 08 466.5

(51) Int. Cl. C03B 19/06

(52) U.S. Cl. 65/17.4

(57) ABSTRACT

A method for producing a quartz glass material with high resistance to radiation-induced density modifications when exposed to ultraviolet radiation at about 193 nm and energy densities of the order of the working energy densities of optical systems for microlithography, in which the peroxy defect level in the quartz glass material is minimized. In this way the creation of closely neighbored hydroxyl groups can be inhibited, which have been identified as an essential cause for radiation induced density reduction of the quartz glass material.

The following disclosure is based on German Patent Application No. 103 08 466.5 filed on Feb. 21, 2003, which is incorporated into this application by reference.

### BACKGROUND OF THE INVENTION

1. Field of the Invention

The invention relates to a method for producing a quartz glass material with high resistance to radiation-induced density modifications when exposed to ultraviolet radiation at about 193 nm and energy densities of the order of the working energy densities of optical systems for microlithography, to a quartz glass material which can be produced by such a method, and to an optical system which contains at least one optical component having this quartz glass material. Optical systems for microlithography are a preferred field of application.

2. Description of the Related Art

Synthetic quartz glass material (fused silica) is extensively required for the production of lenses, prisms and other optical components. The requirement is particularly great in optical systems for microlithography. Here, operation is being carried out with shorter and shorter wavelengths in the ultraviolet range in order to achieve maximum resolutions. Synthetic quartz glass is the preferred material for this down to wavelengths in the range of 248 nm. At shorter wavelengths, for example at 193 nm or 157 nm, synthetic quartz glass is often used in combination with fluoride crystal materials such as calcium fluoride. Optical systems which are predominantly or exclusively made up of quartz glass material components are not likely to be possible owing to increased absorption at 157 nm, although they are sought after at 193 nm.

Many attempts to provide synthetic quartz glass materials for this wavelength range have been reported, these being distinguished by a high transmission for ultraviolet radiation and/or by high resistance to radiation-induced property changes.

DE 199 42 443 A1 (corresponding to U.S. Pat. No. 6,376,401) describes a production method for synthetic silicon dioxide glass with high transmission for ultraviolet radiation as far as wavelengths of 157 nm. A special procedure, which is referred to as the soot process, is intended to make it possible to reduce the level of hydroxyl groups (OH groups) to the range of below about 70 ppm while simultaneously minimizing the level of chlorine and metallic impurities. Minimization of the level of OH groups is sought after in this case with a view to improved transmission, since it is assumed that these hydroxyl groups cause absorption in a particular band of the vacuum ultraviolet range, which leads to a reduction in transmission. On the other hand, it is known from JP 4-97922, for example, that a high level of OH groups should provide a high resistance of the glass to UV laser radiation.

In the soot process, a gaseous silicon compound, for example silicon tetrachloride, is flame-hydrolyzed and the resulting soot is deposited to form a porous silicon dioxide preform. The soot particles themselves are not yet transparent. The vitrification is carried out in a subsequent sintering step, during which the soot is fused and a transparent quartz glass is formed. The process is complex compared with known direct deposition. In direct deposition, a gas containing silicon, for example silicon tetrachloride, is likewise burnt in a kind of jet flame. On a quartz glass seed, further quartz is then deposited which already has a vitreous structure and is rendered transparent by subsequent polishing.

Sufficient transmission of the quartz glass material, however, is only one prerequisite for suitability to be used in highly complex optical systems, for example illumination systems or projection objectives for microlithography. In this context, it is known that laser irradiation with wavelengths of 193 nm, for example, can lead to radiation-induced density modifications of the quartz glass material, which are associated with changes in the refractive index. These changes in the optical properties can sometimes lead to non-rotationally symmetric imaging aberrations in lithography systems, which limit the lifetime of the systems and sometimes necessitate replacement and readjustment.

One effect which has been known for a long time is radiation-induced densification of the quartz glass material, which is associated with an increased refractive index in the irradiated region. This effect is referred to as “compaction”. Compaction is a frequently studied phenomena, which can be demonstrated particularly clearly by irradiation with relatively large energy densities of, for example, more than 0.5 mJ/cm². In order to prevent compaction from occurring to a critical extent at the typical working energy densities and working wavelengths in lithography systems, it has been proposed to pre-irradiate the quartz glass material with high energy densities so that the compaction is substantially anticipated, in order thereby to obtain a material which is relatively stable at the working radiation densities (c.f. e.g. U.S. Pat. No. 6,205,818 B1 and U.S. Pat. No. 6,295,841 B1).

Especially at lower energy densities in the range of the working energy densities of lithography systems, another conflicting effect comes into play which is associated with radiation-induced expansion of the material and causes a reduced refractive index. This effect of a radiation-induced density decrease is referred to as “rarefaction”. Information about this effect can be found in the articles “Radiation effects in hydrogen-impregnated vitreous silica” by J. E. Shelby in J. Appl. Phys. vol. 50, pp. 3702 ff (1979) or “Behavior of Fused Silica Irradiated by Low Level 193 nm Excimer Laser for Tens of Billions of Pulses” by C. K. Van Peski, Z. Bor, T. Embree and R. Morton, Proc. SPIE, vol. 4347, pp. 177 to 186 (2001). No further discoveries about the causes of rarefaction, or measures to avoid or reduce rarefaction, have yet become known.

It is assumed that optical properties of quartz glass materials, for example the absorption behavior, are closely related to the very complex glass network structure of silicon dioxide glass, in which many different defects and defect precursors are normally present. A comprehensive discussion, particularly about possible defects and defect precursors in quartz glass materials, can be found in the article “Optical Properties and Structure of Defects in Silica Glass” by D. L. Griscom, Journal of the Ceramic Society of Japan, Int. Edition, vol. 99-899 (1991). According thereto, distinction is generally made between paramagnetic and diamagnetic intrinsic defects, as well as extrinsic defects. Paramagnetic intrinsic defects include E′ centres (≡Si.), non-bridging oxygen hole centres (NBOHC) (≡Si—O.), peroxy radicals (≡SiO—O.), and self-trapped holes (STH). Examples of suspected diamagnetic intrinsic defects comprise neutral oxygen vacancies (≡Si—Si≡), double-coordinated silicon atoms (—O—Si—O—) and peroxy bonds (≡Si—O—O—Si≡), which are also referred to here as peroxy defects. The most common extrinsic defects occur in conjunction with hydroxyl groups (OH groups) and chloride impurities. The article “Generation mechanism of photoinduced paramagnetic centers from preexisting precursors in high-purity silicas” by H. Nishikawa, R. Nakamura, R. Tohmon, Y. Ohki, Y. Sakurai, K. Nagasawa and Y. Hama in Physical Review B, vol. 41, No 11, pp. 7828 to 7834 explains suspected mechanisms by which photoinduced paramagnetic centres are created from existing precursors in highly pure silicon dioxide.

### SUMMARY OF THE INVENTION

It is an object of the invention to provide a method for producing quartz glass, which makes it possible to provide quartz glass materials whose optical properties do not change, or change only slightly, during prolonged use. The quartz glass materials are intended to be particularly suitable for use in lithography machines. In particular, the resistance to radiation-induced density reduction during use is intended to be increased.

In order to achieve this object, according to one formulation, the invention provides a method for producing a quartz glass material with high resistance to radiation-induced density modifications when exposed to ultraviolet radiation at about 193 nm and energy densities of the order of the working energy densities of optical systems for microlithography, the method including minimizing the peroxy defect level in the quartz glass material. Advantageous refinements are specified in the various claims set forth below. The wording of all claims is incorporated into this description by reference.

The method of the type mentioned above according to the invention is characterized by minimization of the peroxy defect level in the quartz glass material.

The Inventors have found from extensive studies that, among many defects and defect precursors present in conventional quartz glass materials, peroxy defects are very likely to be crucially responsible for the occurrence of rarefaction. It is therefore proposed for the creation of such peroxy defects to be avoided from the start during the quartz glass production or, as an alternative or in addition, that quartz glass materials which have already been produced should be subjected to a retreatment leading to a significant reduction of peroxy defects in the glass network structure of the silicon dioxide glass.

The invention is based on the concept that hydroxyl groups in the quartz glass matrix lead to a loosening of the glass structure owing to their polarity, which results in a reduced density. It is furthermore assumed in this case that the interaction between the hydroxyl groups is commensurately stronger when the hydroxyl groups lie closer together. According to the Inventors' reasoning, hydroxyl groups which lie close together may therefore be an important cause of rarefaction. Hydroxyl groups in immediate proximity can be created by laser irradiation at 193 nm (corresponding to a photon energy of 6.4 eV) when peroxy bonds are broken and saturated with hydrogen. This is because the energy difference between the bonding π orbital and the antibonding σ* orbital is about 6.5 eV. The process regarded here as important for producing closely neighboring hydroxyl groups can be represented as follows:

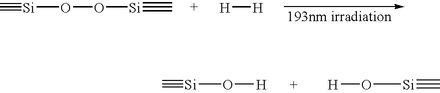

This reaction scheme shows the way in which closely neighboring hydroxyl groups (on the right-hand side of the reaction equation) can be produced from peroxy defects in conjunction with hydrogen (on the left-hand side of the reaction equation), when the material is irradiated with 6.4 eV photons of 193 nm laser radiation.

This being the case, the object of avoiding or reducing rarefaction is intended to be achieved particularly for methods of producing quartz glass material in which the material is produced by direct deposition. In direct deposition, as mentioned, a gas such as SiCI₄ containing silicon is burnt in a kind of jet flame. On a quartz glass seed, further quartz is then deposited which already has a vitreous structure and is therefore transparent after polishing. The deposition process may be followed by further process steps, for example in order to homogenize the glass.

In advantageous method variants, an attempt is made to avoid the creation of peroxy defects as far as possible directly during the production of the quartz glass. According to one refinement, the temperature, gas composition and environment in the flame are selected so that the ozone concentration in the flame is minimized, in particular kept below 2 mol %. A preferred temperature range lies between 1700° C. and 2500° C. The gas composition for the burner gas is preferably based on a stoichiometric ratio between H₂ and O₂, although between 50 and 75 mol % of cold air are admixed. In addition to this, there is also a gas containing silicon, which may for example be an organic silicon compound or SiCl₄. The combustion may also be carried out in the presence of MnO₂ or PbO₂ as a catalyst, in order to promote the decomposition of ozone (2*O₃→3*O₂) in the burner atmosphere. If the concentration of O₃ in the combustion atmosphere is kept low enough, the original creation of peroxy defects can be substantially suppressed since almost no Si—O—O components are then formed in the chemical reaction between the gas containing silicon and the oxygen, and instead essentially only Si—O components are formed.

As an alternative or in addition, the production atmosphere during direct deposition may be adjusted so as to result in a hydrogen concentration (H₂ and H) respectively lower than about 10 mol %. This can also be achieved by the addition of cold air (about 5-40 mol %) to the stoichiometric ratio of H₂ and O₂. It has been found that low hydrogen concentrations in the range of less than about 10¹⁶/cm³ can thereby be achieved in the quartz glass material. If the reaction partner for the peroxy bonds (left-hand side of the reaction equation) is greatly depleted in this way, the reaction to form closely neighboring hydroxyl groups is hindered and can only take place to a negligible extent.

Another variant involves a heat treatment of the quartz glass material at temperatures of between about 100° C. and about 2000° C., in order to expel hydrogen which is present in the quartz glass material. This method also attacks the reaction partner for the peroxy defects, in order to suppress the reaction to form neighboring hydroxyl groups.

This variant offers the possibility of setting up of a hydrogen concentration profile in the quartz glass material; the concentration profile may for example be matched to a rotationally symmetric local distribution of the energy density when the quartz glass material is being used. More hydrogen will diffuse out from the edge regions of a quartz glass preform than from the central region, which leads to a hydrogen content decreasing from the middle of the preform towards the edge. Rarefaction is based on a single-photon process and therefore increases with the energy density. The regions with a high hydrogen content are thus assigned lower energy densities, whereas the regions with a low hydrogen content are suitable for higher energy densities.

Whereas low hydrogen concentrations in the quartz glass material may be favorable for inhibiting the generation of hydroxyl groups for the aforementioned reasons, low hydrogen concentrations of for example less than about 10¹⁶/cm³ in the quartz glass may be problematic for lithography applications. This is the case under progressive irradiation when, for example, there is insufficient saturation of other defects such as E centres due to the hydrogen content being used up. In order to avoid this, the introduction of at least one halogen into the quartz glass material is provided according to one method variant, the halogen being for example fluorine and/or chlorine. The addition of at least one halogen may take place either during the deposition process or subsequently during a heat treatment (temperature between 100° C. and 2000° C.) in an overpressure atmosphere (pressure between 1 mbar and 100 bar) of the corresponding halogen. During the deposition process, it is possible to add the halogen in gas form or introduce it indirectly by burning SiCl₄, for example.

The invention also encompasses possibilities of reducing the level of reactive peroxy defects after the glass production, especially after direct deposition. In particular, a pretreatment of the quartz glass material before use is proposed, which comprises a heat treatment of the quartz glass material at temperatures of between about 100° C. and about 2000° C. in a hydrogen atmosphere at over-pressures of between about 1 mbar and 100 bar. It has been found that this pretreatment can lead to thermal break-up of peroxy defects and subsequent saturation with the aid of hydrogen. The conversion of peroxy defects into hydroxyl groups, which has been identified here as an essential cause of reduced density, can thereby be substantially completed before the quartz glass material is used, for example in a microlithography objective, so that no further significant density changes result during actual use.

Another refinement provides doping of the quartz glass material with at least one substance that does not affect the optical properties of the quartz glass material, or only affects them slightly, which is capable of bringing about charge equilibration between neighboring hydroxyl groups. In this case, the invention affects the final stage of the aforementioned reaction chain. Although it is possible that closely neighboring hydroxyl groups may to some extent be created by this, this configuration that leads per se to a reduced density is nevertheless hindered since charge equilibration is brought about between the neighboring hydroxyl groups. For example, the substance which ensures for charge equilibration may contain at least one metal oxide, for example MgO, CaO, SrO or BaO.

The above and further features are divulged both by the claims and by the description, and the individual features may respectively be implemented alone or together to form of sub-combinations in an embodiment of the invention and in other fields, and constitute both advantageous embodiments, protected under the present patent application. An exemplary embodiment will be explained in detail below.

### DETAILED DESCRIPTION OF THE PREFERRED EMBODIMENTS

Exemplary Embodiment 1

The invention will be explained by way of example with reference to the production of radiation-resistant quartz glass material in a direct deposition method. In direct deposition, a gas containing silicon, which contains silicon tetrachloride (SiCl₄), is burnt in a kind of jet flame. Further quartz is then deposited on a prepared quartz glass seed. The deposited quartz already has a vitreous structure and is transparent after polishing.

In a preferred method, the production conditions are adjusted so that the concentration of ozone molecules (O₃) in the flame is minimal. Ozone concentrations of less than about 2 mol % are desirable. To this end, the flame temperature is adjusted to temperatures of between 2000 and 2500° C. The gas composition for the burner gas is preferably based on a stoichiometric ratio between H₂ and O₂, and between about 50 and 75 mol % of cold air are admixed to this ratio. A gas containing silicon is furthermore admixed, for example an organic silicon compound or silicon tetrachloride. The combustion is carried out in the presence of at least one catalyst in order to break down substantially any ozone molecules which occur, and convert them into oxygen molecules. Manganese oxide (MnO₂) and/or lead oxide (PbO₂) are particularly suitable, for example. Combustion atmospheres with an extremely low ozone content were produced in this way. It is assumed that predominantly Si—O components are formed during the ozone-depleted combustion in the chemical reaction between the gas containing silicon and the oxygen, and the formation of detrimental Si—O—O components (peroxy defects) is substantially suppressed. It is favorable for the production atmosphere during direct deposition to be adjusted so as to result in H₂ and H concentrations respectively lower than about 10 mol %. It has been found that this can be done by adding cold air to the gas to be burnt, for example to the extent of about 5-40 mol %.

The above description of the embodiments has been by way of example. From the disclosure given, those skilled in the art will not only understand the present invention and its attendant advantages, but will also find apparent various changes and modifications to the structures and methods disclosed. It is sought, therefore, to cover all changes and modifications as fall within the spirit and scope of the invention, as defined by the appended claims, and equivalents thereof.

1. A method for producing a quartz glass material with high resistance to radiation-induced density modifications when exposed to ultraviolet radiation at about 193 nm and energy densities of the order of the working energy densities of optical systems for microlithography, comprising minimizing the peroxy defect level in the quartz glass material.

2. The method according to claim 1, wherein the quartz glass material is produced by direct deposition.

3. The method according to claim 1, wherein the quartz glass material is produced by a soot process.

4. The method according to claim 1, wherein the temperature, gas composition and environment in a production flame are selected so that the ozone concentration in the flame is minimized.

5. The method according to claim 4, wherein the ozone concentration in the flame is kept below 2 mol %.

6. The method according to claim 4, wherein cold air is added to a substantially stoichiometric mixture of H₂ and O₂ in order to adjust the gas composition.

7. The method according to claim 4, wherein the combustion is carried out in the presence of at least one catalyst that promotes the breakdown of ozone molecules into oxygen molecules.

8. The method according to claim 1, wherein a hydrogen concentration during the production is set sufficiently low to achieve low hydrogen concentrations in a range of less than about 10¹⁶/cm³ in the quartz glass material.

9. The method according to claim 1, wherein a heat treatment of the quartz glass material is carried out at temperatures of between about 100° C. and about 2000° C.

10. The method according to claim 1, further comprising setting up a local hydrogen concentration profile in the quartz glass material.

11. The method according to claim 10, wherein the local hydrogen concentration profile is matched to a local distribution of the energy density when the quartz glass material is in use.

12. The method according to claim 1, further comprising introducing at least one halogen into the quartz glass material.

13. The method according to claim 12, wherein the halogen is at least one of fluorine and chlorine.

14. The method according to claim 1, further comprising pretreating the quartz glass material before use, the pretreatment comprising a heat treatment of the quartz glass material at temperatures of between about 100° C. and about 2000° C. in a hydrogen atmosphere at overpressures of between about 1 mbar and 100 bar.

15. The method according to claim 1, further comprising doping the quartz glass material with at least one substance that substantially does not affect the optical properties of the quartz glass material, but that is selected to bring about charge equilibration between neighboring hydroxyl groups.

16. A quartz glass material, having a low peroxy defect concentration.

17. The quartz glass material according to claim 16, configured for use in a lithography machine.

18. The quartz glass material according to claim 16, having a low hydrogen concentration in the range of less than about 10¹⁶/cm³.

19. The quartz glass material according to claim 16, which is produced by direct deposition.

20. A quartz glass material, produced by a method according to claim 1.

21. The quartz glass material according to claim 20, configured for use in a lithography machine.

22. An opticall system comprising at least one optical component having quartz glass material according to claim 16.

23. The optical system according to claim 22, configured for use in a lithography machine.

24. The optical system according to claim 22, which is designed as an illumination system or as a projection objective for a microlithography projection exposure system.

25. A method for producing a quartz glass material with high resistance to radiation-induced density modifications when exposed to ultraviolet radiation at about 193 nm and energy densities of the order of the working energy densities of optical systems for microlithography, comprising minimizing the peroxy defect level in the quartz glass material, wherein the quartz glass material is produced by direct deposition, and wherein the temperature, gas composition and environment in a production flame are selected so that the ozone concentration in the flame is minimized.

26. The method according to claim 25, wherein cold air is added to a substantially stoichiometric mixture of H₂ and O₂ in order to adjust the gas composition.

27. The method according to claim 25, wherein the combustion is carried out in the presence of at least one catalyst that promotes the breakdown of ozone molecules into oxygen molecules.

28. A method for producing a quartz glass material with high resistance to radiation-induced density modifications when exposed to ultraviolet radiation at about 193 nm and energy densities of the order of the working energy densities of optical systems for microlithography, comprising minimizing the peroxy defect level in the quartz glass material, wherein a hydrogen concentration during the production is set sufficiently low to achieve low hydrogen concentrations in a range of less than about 10¹⁶/cm³ in the quartz glass material, and wherein a heat treatment of the quartz glass material is carried out at temperatures of between about 100° C. and about 2000° C.

29. The method according to claim 28, further comprising setting up a local hydrogen concentration profile in the quartz glass material.

30. A method for producing a quartz glass material with high resistance to radiation-induced density modifications when exposed to ultraviolet radiation at about 193 nm and energy densities of the order of the working energy densities of optical systems for microlithography, comprising:
minimizing the peroxy defect level in the quartz glass material, and
introducing at least one halogen into the quartz glass material,
wherein the quartz glass material is produced by direct deposition.

31. A method for producing a quartz glass material with high resistance to radiation-induced density modifications when exposed to ultraviolet radiation at about 193 nm and energy densities of the order of the working energy densities of optical systems for microlithography, comprising:
minimizing the peroxy defect level in the quartz glass material;
introducing at least one halogen into the quartz glass material; and
pretreating the quartz glass material before use, the pretreatment comprising a heat treatment of the quartz glass material at temperatures of between about 100° C. and about 2000° C. in a hydrogen atmosphere at overpressures of between about 1 mbar and 100 bar.
